(19) United States
(12) Patent Application Publication
(10) Pub. No.: US 2022/0309585 A1
(43) Pub. Date: Sep. 29, 2022

(54) Multi-Broker Concurrent Portfolio Management System and Method

(71) Applicant: SU2 Systems, Inc., Lansing, MI (US)

(72) Inventors: Paresh J. Malde, Lansing, MI (US); Franklin Gold, Lansing, MI (US); Jonah Guettler, Lansing, MI (US); Vaughn Anderson, Lansing, MI (US); Paul Seyfarth, Lansing, MI (US)

(21) Appl. No.: 17/619,685

(22) PCT Filed: Jun. 16, 2020
(86) PCT No.: PCT/US2020/037893

§ 371 Date: Dec. 16, 2021

Related U.S. Application Data
(60) Provisional application No. 62/863,491, filed on Jun. 19, 2019.

(51) Int. Cl. G06Q 40/06

(52) U.S. Cl. CPC G06Q 40/06

(57) ABSTRACT

A multi-broker system comprising: (a) one or more routing systems in communication with multiple broker accounts; and (b) a computer displaying one or more outputs from the one or more routing systems; and wherein the one or more outputs combine information from the multiple broker accounts into a single display so that information from all of the multiple brokers are visible simultaneously.

### CROSS-REFERENCE TO RELATED APPLICATION(S)

This application is a National Stage Application of International Application Serial No. PCT/US2020/037893, filed on Dec. 24, 2021, which claims priority to U.S. Application Ser. No. 62/863,491, filed on Jun. 19, 2019, the entire disclosures of which are hereby incorporated by reference.

### FIELD

The present teachings relate to system and method for concurrently reviewing and managing investment portfolios of multiple brokerage accounts; dynamically switching between two or more different asset types or brokerage accounts; setting different trade defaults and/or rules for different accounts, investment types, assets, corporations, or a combination thereof; providing an aggregate risk of the total portfolio across all of the multiple different brokerage accounts; or a combination thereof.

### BACKGROUND

Currently a user may buy and sell stocks and other assets using a computer by accessing an online trading system. If a user has investments at more than one brokerage firm the user would have to sign into each account individually and view the assets held at that brokerage firm and/or brokerage accounts. If a user wanted to understand the positions held at more than one of the brokerage firms and/or brokerage accounts the user would need to manually track all of the investments. Some examples of brokerage systems and methods may be found in U.S. Pat. No. 8,239,306 and U.S. Patent Application Publication No. 2007/0174146; 2012/0278260; 2016/0210692; and 2019/0164453; and International Patent Application Publication No. WO2012/095839 all of which are expressly incorporated by reference herein for all purposes.

It would be attractive to have a system that accesses multiple brokerage accounts across multiple different brokers simultaneously. What is needed is a system that allows a user to define rules that allow a user to automatically switch between the different multiple brokerage accounts when trading different asset types. It would be attractive to have a system that dynamically orders and routes different types of orders to different brokerage accounts according to user defined defaults and/or rules. What is needed is a system and method of aggregating risk of a total portfolio across all of the multiple brokerage accounts. It would be attractive to have a system and method of dynamically switching between brokerage accounts depending upon an investment type, asset type, corporation, or a combination thereof.

### SUMMARY

The disclosure meets one or more of the needs by providing: a multi-broker system comprising: (a) one or more routing systems in communication with multiple broker accounts; and (b) a computer displaying one or more outputs from the one or more routing systems; and wherein the one or more outputs combine information from the multiple broker accounts into a single display so that information from all of the multiple brokers are visible simultaneously.

The teachings herein provide: a method comprising: (a) connecting one or more routing systems to multiple different broker accounts; (b) aggregating data from the multiple different brokers; and (c) outputting the aggregated data from the multiple different broker accounts into a single output and displaying the aggregated data on a single display so that information from all of the multiple broker accounts are visible simultaneously.

The teachings herein provide: a system comprising: (a) one or more routing systems in communication with two or more broker accounts and real-time information regarding assets held within each of the two or more broker accounts; (b) a computer displaying one or more outputs from the one or more routing systems; and (c) one or more windows that display an aggregation of risk of all of the two or more broker accounts.

The teachings herein provide: a method comprising: (a) connecting one or more routing systems to multiple different broker accounts; (b) aggregating data from the multiple different broker accounts; (c) connecting the one or more routing systems to real-time information regarding assets held within each of the multiple different broker accounts; (d) calculating an aggregation of risk for all of the assets held within the multiple different broker account; and (e) outputting the aggregation of risk for all of the assets held within the multiple different broker accounts into a single output and displaying the aggregation of risk on a single display so that the aggregation of risk from all of the multiple broker accounts are visible simultaneously.

The teachings herein provide: a method comprising: (a) connecting one or more routing systems to multiple different broker accounts; (b) aggregating data from the multiple different brokers; (c) outputting the aggregated data from the multiple different broker accounts into a single output; and (d) inquiring whether an asset symbol is located within the aggregated data.

The teachings herein provide: a method comprising the multi-broker system taught herein.

The teachings herein provide a system taught herein performing the method taught herein.

The teachings herein provide a system that accesses multiple brokerage accounts across multiple different brokers simultaneously. The teachings herein provide a system that allows a user to define rules that allow a user to automatically switch between the different multiple brokerage accounts when trading different asset types. The teachings herein provide a system that dynamically orders and routes different types of orders to different brokerage accounts according to user defined defaults and/or rules. The teachings herein provide a system and method of aggregating risk of a total portfolio across all of the multiple brokerage accounts. The teachings herein provide a system and method of dynamically switching between brokerage accounts depending upon an investment type, asset type, corporation, or a combination thereof.

### BRIEF DESCRIPTION OF THE DRAWINGS

FIG. 1 illustrates a multi-broker system in communication with two accounts of different types of assets.

FIG. 2 illustrates an account overview and two account types of the multi-broker system.

FIG. 3 illustrates a multi-broker system in communication with three accounts and management of the accounts within a single system.

FIG. 4 is flow chart illustrating a purchase when a symbol is entered into the system.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The teachings herein provide a system. Preferably, the system is a multi-broker account system. The system functions to provide management of two or more accounts. The system may provide access a single individual's accounts at two or more brokers. The system may provide access to two or more individual's accounts at a single broker or two or more brokers. The multi-broker system may compile multiple accounts into a single window or single display. The multi-broker system may display asset type, asset symbols, or both in a single window or single display. The multi-broker system may aggregate all of the multiple accounts, all of the account types, all of the asset types, all of the asset symbols, all of the accounts, or a combination thereof into a single display or a single window so that all of the desired information (e.g., accounts, account types, asset symbols) are visible simultaneously. The system may include an account overview.

The account overview may function to allow a user to customize a desired view. The account overview may display accounts to be displayed, account types to be displayed, asset types to be displayed, asset symbols to be displayed, broker accounts to be displayed, user input criteria, or a combination thereof. The account overview may allow a user to toggle between different views. The account overview may allow a user to change input criteria. The account overview may display all of the accounts individually. The account overview may display all of the account types. The account overview may display all of the asset types. The account overview may display all of the asset symbols. The account overview may allow a user to toggle between accounts, account types, asset types, asset symbols, or a combination thereof.

The accounts may be each of the individual accounts at each of the brokers. All of the multiple different accounts may be at a single broker with different logins. All of the multiple different accounts may be located at one or more brokers and preferably two or more different brokers. The accounts may include stocks, bonds, mutual funds, index funds, exchange traded funds, options, forex, futures, cash, cd's, cash management accounts, reits, or a combination thereof. The accounts may include one or more account types. Preferably, each account includes a plurality of different account types.

The system may divide all of the plurality of accounts by account type. The account type may be similar types of assets as discussed herein. For example, one account type may include stocks and another account type may include futures. The account types as discussed herein may be stocks, bonds, mutual funds, index funds, exchange traded funds, options, forex, futures, cash, cd's, cash management accounts, reits, or a combination thereof. Each account type may include a plurality of assets of the asset type. For example, the account type (e.g., equity account or future account) may include a plurality of assets of that type. For example, the account type may include a plurality of future asset types.

The asset types may be one or a plurality of assets of a give type aggregated together to demonstrate a user's position regarding a given type of assets. The asset types once aggregated together may provide a user with an entire position of a specific asset type within an account type. The asset types may be aggregated together in an account type so that risk management of that asset type across all accounts may be ascertained. The asset types may be an aggregation of a plurality of asset symbols.

The asset symbols may function to provide a name of an asset. For example, the asset symbol may represent a name of a stock of a publicly traded corporation. The asset symbols may represent an asset that is owned. The asset symbol may represent an asset that is being watched, desired to be purchased, or both. The asset symbol may be a ticker symbol. The asset symbol may be manually or automatically inputted into a routing system.

The routing system may function to connect to the multiple broker accounts simultaneously. The routing system may aggregate all of the data from all of the multiple broker accounts simultaneously. The routing system may connect the broker accounts to a computer, a display, or both. The routing system may organize all of the assets by account, account type, asset type, asset symbols, or a combination thereof. The routing system may request, collect, store, or a combination thereof user input criteria. The routing system may be on the cloud. The routing system may be downloaded onto a personal computer. The routing system may link multiple accounts together and then aggregate the information from all of the multiple accounts. The routing system may display information from multiple different accounts simultaneously. The routing system may generate an output that is displayed upon a display device. The output from the routing system may be modified based upon user input criteria.

The user input criteria may be a collection of data provided by the user to determine how data from the multiple different accounts are displayed. The user input criteria may be buying, selling, trading, options, day, month, year, quantity, maximum quantity, minimum quantity, trailing stop, or a combination thereof. The input criteria may be predetermined or may be a default. The input criteria may be predetermined for an asset type, an account, an account type, an asset symbol, or a combination thereof. The input criteria may be input through a display, a computer, or both.

The computer may function as a display, in input, or both. The computer may be connected to the internet, a routing system, real time market data, or a combination thereof. The computer may be a personal computer. The computer may include one or more windows so that a user may toggle between the accounts, account types, asset types, or a combination thereof. The computer the routing system, or both may be connected to real time market data.

The real time market data may function to provide a current position of an account, account type, asset type, asset symbol, a current asset, a future asset, an asset being watched, or a combination thereof. The real time market data may be provided in real time based upon current market conditions (e.g., stock exchange). The real time market data may be displayed as a chart, graph, ticker, number, volume, buying, selling, or a combination thereof. The real time market data may be supplied to a user along with asset types or asset symbols from all of the accounts simultaneously.

The method may function to simultaneously provide access to multiple broker systems. The system may be connected to one or more routing system. The system may connect one or more routing system to multiple different brokers. The system aggregate data from the multiple different broker accounts. The system may output the aggregated date from the multiple different broker accounts to a display or a computer. The system may output all information to a single display. The single display may display all of the accounts, assets, asset types, or a combination thereof at a single time. The method may combine broker accounts together. The method may aggregate each of the account types together. The method may create windows for each of the account types. The method may allow a user to toggle between multiple windows, asset types, assets, asset symbols, or a combination thereof. The method may access real time data. The method may populate a single output with real time data regarding all of the assets held in all of the multiple different broker accounts. The rules or defaults may be defined. A watch list may be populated. Rules or defaults may be varied depending upon symbol, broker account, type of broker account, trading, buying, selling, shorting, quantity, maximum quantity, month, day year, trailing stop, asset type, or a combination thereof. The method may aggregate risk for all of the broker accounts, each account, each account type, each asset type, each asset symbol, or a combination thereof. The method may aggregate risk in one or more windows, two or more windows, or three or more windows so that the user may toggle between each window to determine an aggregate of risk based upon the criteria of each window. The criteria may be an account, asset type, account type, asset symbol, or a combination thereof. The aggregate of risk may be calculated based upon an entire portfolio, account, account type, asset type, asset symbol, or a combination thereof. The aggregation of risk may be a potential asset on a watch list. The aggregation of risk may be calculated for an entire portfolio including one or more assets on a watch list or potential assets. The method may determine if an asset symbol is located within the aggregated data. If an inquiry states that an asset symbol is within the aggregated data then predetermined rule or defaults are maintained for the asset symbol. If an inquiry states that the asset symbol is new then the method requests predetermined rules or defaults to be established. The predetermined rules or defaults may relate to asset type, order type, brokerage account, trading, buying, selling, shorting, quantity, maximum, quantity, month, day, year, trailing stop, or a combination thereof. The system requests an order. The system determines an order route. The system directs an order for an asset symbol. The order is routed on one of the broker accounts. The order is directed based upon account, account type, asset type, asset symbol, or a combination thereof.

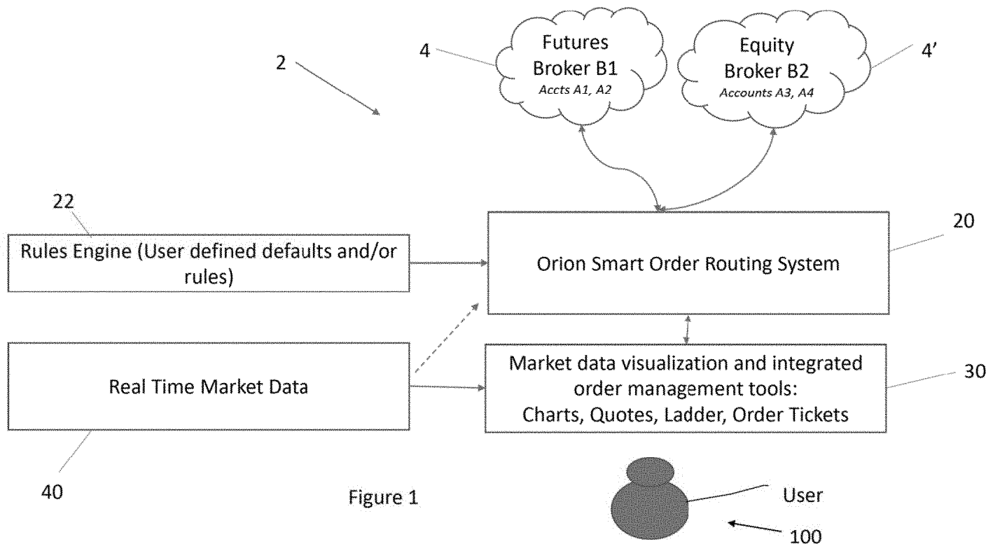

FIG. 1 illustrates a multi-broker system 2 including a routing system 20 connected to a computer 30 that a user accesses to view and control all of the users accounts 4 and 4′. The routing system 20 is simultaneously in communication with all of the accounts 4 and 4′ and then generates a visualization on the computer 30 for the user 100. The routing system 20 accesses real-time market data 60 (e.g., via the internet or stock exchange) to provide a user 100 with real-time information as to a position in each of the respective accounts 4 and 4′. Information provided through the computer 30 may be provided via user input criteria 22 or may be traded in one or more of the accounts 4 and 4′ via the user input criteria 22.

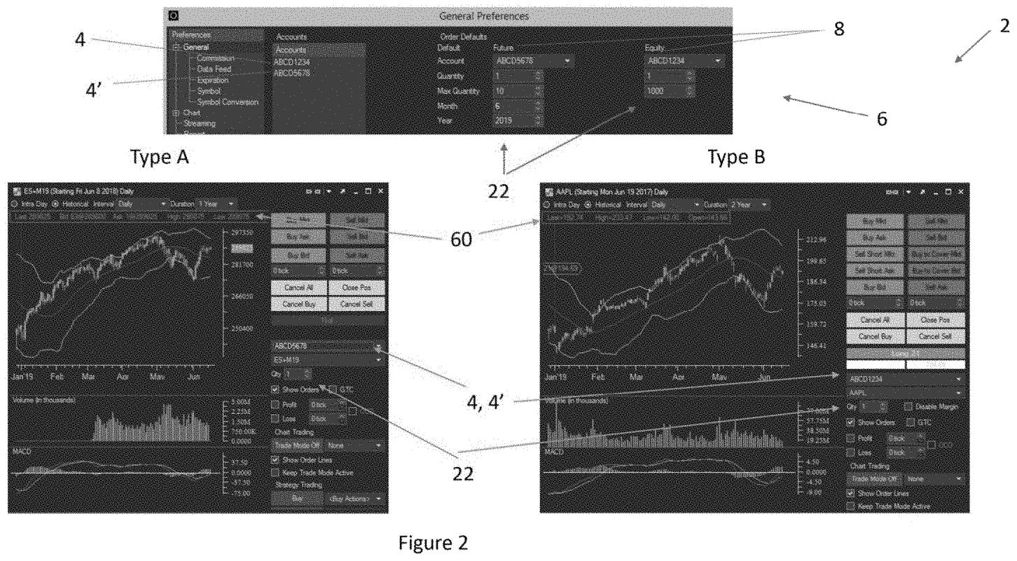

FIG. 2 illustrates the multi-broker system 2 with an account overview 6 showing both of the accounts 4 and 4′. The account overview 6 demonstrates the account type 8 with the user input criteria 22 for each account type. As shown, account 4 is a future account and account 4′ is an equity account. Below the account overview 6 are each of the different types of accounts 4 and 4′ depicting the real-time market data 60, the account numbers 4 and 4′, and the user input criteria 22. Each of the accounts provides all of the real-time market data 60 for each account type for all of the accounts 4 and 4′ so that all of a current position is visible while trading a position.

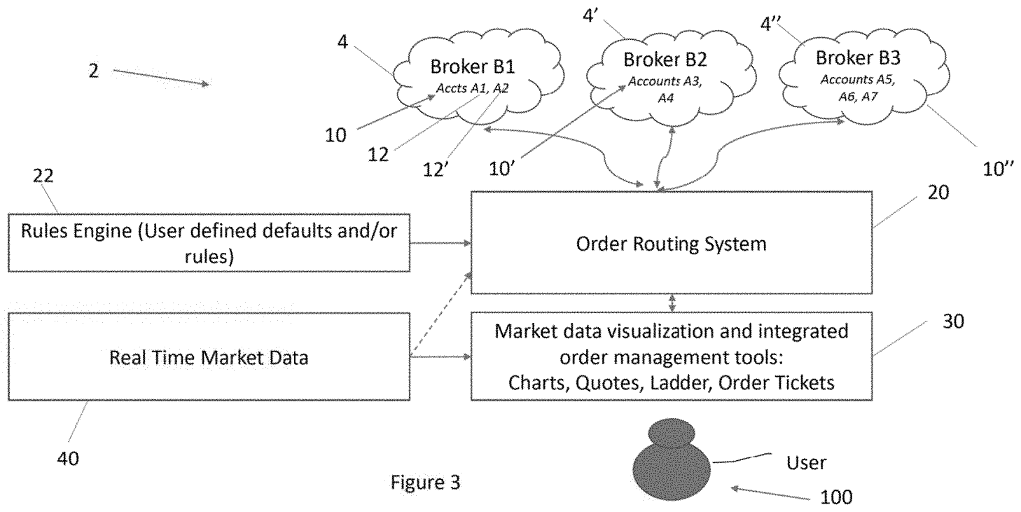

FIG. 3 illustrates the multi-broker system 2 connecting three accounts 4, 4′ and 4″ to an order routing system 20 and ultimately to a computer 30 for the user 100. The first account 4 has a first asset type 10, the second account 4′ has a second asset type 10′ and the third account 4″ has a third asset type 10″. Each asset type has a plurality of symbols. The first asset type 10 includes a first symbol 12 and a second symbol 12′ of the first asset type 10. Real-time data from each account is fed into the routing system 20 and pared with real-time market data 60 as set forth in the user input criteria 22 and then provided to the user 100 via the computer 30. Thus, the user 100 can visualize all of the accounts 4, 4′, and 4″ and all of the asset types 10, 10′, and 10″ simultaneously on one system at one time.

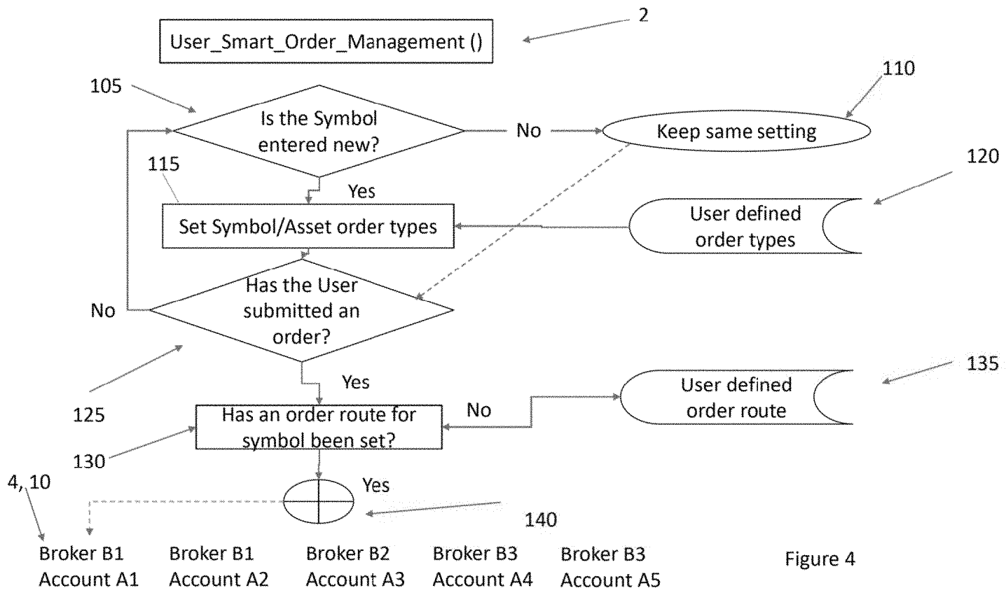

FIG. 4 illustrates a multi-broker system 2 and managing a trade within the multi-broker system 2. Once a symbol is entered into the system 105 the system identifies if the symbol is a new symbol. If the symbol 105 not new then the settings (e.g., user input criteria) are maintained for the symbol 110 and the system determines if an order has been submitted by the user 125. If the symbol is new 105 then the system requests user input criteria to set the symbol and order type 115. The user will define the order type 120 to populate the user input criterial. Once all of the user input criteria is either inputted confirmed an order route will be reviewed 130. If an order route has not been defined then the system will request an order route to be defined 135. Once the order route is defined 130 then the order will be executed 140 into the account 4 for the asset type 10 that has been determined for that symbol.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. Unless otherwise stated, a teaching with the term “about” or “approximately” in combination with a numerical amount encompasses a teaching of the recited amount, as well as approximations of that recited amount. By way of example, a teaching of “about 100” encompasses a teaching of within a range of 100+/−15.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

Variation 1 may comprise: a multi-broker system comprising: (a) one or more routing systems in communication with multiple broker accounts; and (b) a computer displaying one or more outputs from the one or more routing systems; and wherein the one or more outputs combine information from the multiple broker accounts into a single display so that information from all of the multiple brokers are visible simultaneously.

Variation 2 may comprise variation 1 and any number of combinations of variations 3-44 and may comprise the one or more routing systems combine data from each of the multiple broker accounts and provides the data to the computer as the one or more outputs.

Variation 3 may comprise the variations 1-2 and any number of combinations of variations 4-44 and may comprise the one or more routing systems have one or more user input criteria that a user inputs into the one or more routing systems.

Variation 4 may comprise the variations 1-3 and any number of combinations of variations 5-44 and may comprise the one or more user input criteria are a rule, a quantity, a maximum quantity, a month, a year, type of account, trailing stop, a purchase, a sale, or a combination thereof.

Variation 5 may comprise the variations 1-4 and any number of combinations of variations 6-44 and may comprise the order routing system accesses real-time data regarding an asset.

Variation 6 may comprise the variations 1-5 and any number of combinations of variations 7-44 and may comprise wherein the real-time data is sales volume, sales price, sales high, sales low, current profit, current loss, buying, selling, a graph, ticker symbol, the user input criteria, date, years, historical trends, purchase on margin, or a combination thereof.

Variation 7 may comprise the variations 1-6 and any number of combinations of variations 8-44 and may comprise the real-time data is accessed via the internet.

Variation 8 may comprise the variations 1-7 and any number of combinations of variations 9-44 and may comprise the real-time data is incorporated into the one or more outputs before the one or more outputs are displayed to the user.

Variation 9 may comprise the variations 1-8 and any number of combinations of variations 10-44 and may comprise the single display provides a display of all of the accounts, assets, asset types, or a combination thereof simultaneously at a single time.

Variation 10 may comprise the variations 1-9 and any number of combinations of variations 11-44 and may comprise the system displays only one asset type from each account at one time, displays only one account at a time, displays only one asset symbol at a time, displays all symbols of an asset type at one time, or a combination thereof.

Variation 11 may comprise the variations 1-10 and any number of combinations of variations 12-44 and may comprise the system display can be toggled between different accounts, different symbols, different account types, different asset types, or a combination thereof from the single display or a single computer without changing between each of the multiple brokers, or by toggling within the single display.

Variation 12 may comprise the variations 1-11 and any number of combinations of variations 13-44 and may comprise the multiple broker accounts are two brokers or more, three brokers or more, or four brokers or more.

Variation 13 may comprise the variations 1-12 and any number of combinations of variations 14-44 and may comprise a method comprising: (a) connecting one or more routing systems to multiple different broker accounts; (b) aggregating data from the multiple different brokers; and (c) outputting the aggregated data from the multiple different broker accounts into a single output and displaying the aggregated data on a single display so that information from all of the multiple broker accounts are visible simultaneously.

Variation 14 may comprise the variations 1-13 and any number of combinations of variations 15-44 and may comprise the method includes a step of combining asset types together and displaying each asset type in a display for each of the asset types.

Variation 15 may comprise the variations 1-14 and any number of combinations of variations 16-44 and may comprise the method includes a step of toggling between each of the displays for each of the asset types.

Variation 16 may comprise the variations 1-15 and any number of combinations of variations 17-44 and may comprise a step of creating a display for each of the multiple different broker accounts.

Variation 17 may comprise the variations 1-16 and any number of combinations of variations 18-44 and may comprise a step of toggling between the display for each of the multiple different broker accounts.

Variation 18 may comprise the variations 1-17 and any number of combinations of variations 19-44 and may comprise a step of accessing real-time data and populating the single output with real time data regarding assets held in each of the multiple different broker accounts.

Variation 19 may comprise the variations 1-18 and any number of combinations of variations 20-44 and may comprise a step of populating real-time data for symbols of assets on a watch list for each of the multiple different broker accounts.

Variation 20 may comprise the variations 1-19 and any number of combinations of variations 21-44 and may comprise a step of defining rules or defaults.

Variation 21 may comprise the variations 1-20 and any number of combinations of variations 22-44 and may comprise wherein the rules or the defaults are defined for each of the asset types, each symbol held in each of the multiple different broker accounts, each of the multiple different broker accounts, trading, buying, selling, shorting, quantity, maximum quantity, month, day, year, trailing stop, or a combination thereof.

Variation 22 may comprise the variations 1-21 and any number of combinations of variations 23-44 and may comprise a step of customizing the defaults or rules, displaying the defaults or rules, or a combination thereof.

Variation 23 may comprise the variations 1-22 and any number of combinations of variations 24-44 and may comprise the system of any of variations 1-12.

Variation 24 may comprise the variations 1-23 and any number of combinations of variations 25-44 and may comprise the method of any of variations 13-22.

Variation 25 may comprise the variations 1-24 and any number of combinations of variations 26-44 and may comprise a system comprising: (a) one or more routing systems in communication with two or more broker accounts and real-time information regarding assets held within each of the two or more broker accounts; (b) a computer displaying one or more outputs from the one or more routing systems; and (c) one or more windows that display an aggregation of risk of all of the two or more broker accounts.

Variation 26 may comprise the variations 1-25 and any number of combinations of variations 27-44 and may comprise the aggregation of risk is determined for each asset type in all of the two or more broker accounts.

Variation 27 may comprise the variations 1-26 and any number of combinations of variations 28-44 and may comprise the aggregation of risk is displayed based upon user defined defaults or rules.

Variation 28 may comprise the variations 1-27 and any number of combinations of variations 19-44 and may comprise the aggregation of risk dynamically changes as the real-time information changes.

Variation 29 may comprise the variations 1-28 and any number of combinations of variations 30-44 and may comprise wherein the aggregation of risk is displayed in a first window for a total assets held within all of the two or more broker accounts, a second window displays the aggregation of risk for a first asset type, and a third window displays the aggregation of risk for a second asset type.

Variation 30 may comprise the variations 1-29 and any number of combinations of variations 31-44 and may comprise the one or more routing systems route assets based upon the aggregation of risk so that lower risk assets are routed before higher risk assets or vice versa.

Variation 31 may comprise the variations 1-30 and any number of combinations of variations 32-44 and may comprise a method comprising: (a) connecting one or more routing systems to multiple different broker accounts; (b) aggregating data from the multiple different broker accounts; (c) connecting the one or more routing systems to real-time information regarding assets held within each of the multiple different broker accounts; (d) calculating an aggregation of risk for all of the assets held within the multiple different broker account; and outputting the aggregation of risk for all of the assets held within the multiple different broker accounts into a single output and displaying the aggregation of risk on a single display so that the aggregation of risk from all of the multiple broker accounts are visible simultaneously.

Variation 32 may comprise the variations 1-31 and any number of combinations of variations 33-44 and may comprise wherein the aggregation of risk is calculated for a total portfolio.

Variation 33 may comprise the variations 1-32 and any number of combinations of variations 34-44 and may comprise wherein the aggregation of risk is calculated for each asset type.

Variation 34 may comprise the variations 1-33 and any number of combinations of variations 35-44 and may comprise wherein the aggregation of risk is calculated for each asset within each of the multiple different broker accounts

Variation 35 may comprise the variations 1-34 and any number of combinations of variations 36-44 and may comprise wherein the aggregation of risk is varied based upon user defined defaults or rules.

Variation 36 may comprise the variations 1-35 and any number of combinations of variations 37-44 and may comprise an aggregation of risk is calculated for potential assets on a watch list.

Variation 37 may comprise the variations 1-36 and any number of combinations of variations 38-44 and may comprise wherein the aggregation of risk is calculated for the potential assets on the watch list including assets owned in all of the multiple different broker accounts so that the aggregation of risk including the potential assets is visible.

Variation 38 may comprise the variations 1-37 and any number of combinations of variations 39-44 and may comprise a method comprising: (a) connecting one or more routing systems to multiple different broker accounts; (b) aggregating data from the multiple different brokers; (c) outputting the aggregated data from the multiple different broker accounts into a single output; and inquiring whether an asset symbol is located within the aggregated data.

Variation 39 may comprise the variations 1-38 and any number of combinations of variations 40-44 and may comprise wherein if the inquiry states that the asset symbol is within the aggregated data then predetermined rules or defaults are maintained for the asset symbol.

Variation 40 may comprise the variations 1-39 and any number of combinations of variations 41-44 and may comprise wherein if the inquiry states that the asset symbol is new then the method requests predetermined rules or defaults to be established.

Variation 41 may comprise the variations 1-40 and any number of combinations of variations 42-44 and may comprise wherein the predetermined rules or defaults are an asset type, order type, brokerage account, trading, buying, selling, shorting, quantity, maximum quantity, month, day, year, trailing stop, or a combination thereof.

Variation 42 may comprise the variations 1-41 and any number of combinations of variations 43-44 and may comprise wherein the system requests an order.

Variation 43 may comprise the variations 1-42 and any number of combinations of variations 44 and may comprise wherein an order route is set for the asset symbol.

Variation 44 may comprise the variations 1-43 may comprise wherein the order is routed to a predetermined one of the multiple different broker accounts.

### REFERENCE NUMERALS

2 Multi-Broker System
4 Account
4′ Account
4″ Account
6 Account Overview
8 Account type
10 Asset type
10′ Asset type
10″ Asset type
12 Asset Symbol
20 Routing system
22 User input criteria
30 Computer
60 Real time market data
100 User
105 Enter symbols
110 Keep settings
115 Set User input Criteria
120 Define order type
125 Submit order
130 Set order route
135 Define order route
140 Execute order

1) A multi-broker system comprising:
a. one or more routing systems in communication with multiple broker accounts; and
b. a computer displaying one or more outputs from the one or more routing systems; and
wherein the one or more outputs combine information from the multiple broker accounts into a single display so that information from all of the multiple brokers are visible simultaneously.

2) The multi-broker system of claim 1, wherein the one or more routing systems combine data from each of the multiple broker accounts and provides the data to the computer as the one or more outputs.

3) The multi-broker system of claim 1, wherein the one or more routing systems have one or more user input criteria that a user inputs into the one or more routing systems, and the one or more user input criteria are a rule, a quantity, a maximum quantity, a month, a year, type of account, trailing stop, a purchase, a sale, or a combination thereof.

4) The multi-broker system of claim 1, wherein the order routing system accesses real-time data regarding an asset, and the real-time data is sales volume, sales price, sales high, sales low, current profit, current loss, buying, selling, a graph, ticker symbol, the user input criteria, date, years, historical trends, purchase on margin, or a combination thereof.

5) The multi-broker system of claim 1, wherein the real-time data is incorporated into the one or more outputs before the one or more outputs are displayed to the user, and the real-time data is accessed via the internet.

6) The multi-broker system of claim 1, wherein the single display provides a display of all of the accounts, assets, asset types, or a combination thereof simultaneously at a single time; the system displays only one asset type from each account at one time, displays only one account at a time, displays only one asset symbol at a time, displays all symbols of an asset type at one time, or a combination thereof; or both.

7) The multi-broker system of claim 1, wherein the system display can be toggled between different accounts, different symbols, different account types, different asset types, or a combination thereof from the single display or a single computer without changing between each of the multiple brokers, or by toggling within the single display, and the multiple broker accounts are two brokers or more, three brokers or more, or four brokers or more.

8) A method comprising:
a. connecting one or more routing systems to multiple different broker accounts;
b. aggregating data from the multiple different brokers; and
c. outputting the aggregated data from the multiple different broker accounts into a single output and displaying the aggregated data on a single display so that information from all of the multiple broker accounts are visible simultaneously.

9) The method of claim 8, wherein the method includes a step of combining asset types together and displaying each asset type in a display for each of the asset types.

10) The method of claim of claim 8, wherein the method includes a step of toggling between each of the displays for each of the asset types or each of the multiple different broker accounts.

11) The method of claim 8, wherein the method includes a step of creating a display for each of the multiple different broker accounts; a step of customizing the defaults or rules, displaying the defaults or rules, or a combination thereof; or both.

12) The method of claim 8, wherein the method includes a step of accessing real-time data and populating the single output with real time data regarding assets held in each of the multiple different broker accounts, and populating real-time data for symbols of assets on a watch list for each of the multiple different broker accounts.

13) The method of claim 8, wherein the method includes a step of defining rules or defaults and the rules or the defaults are defined for each of the asset types, each symbol held in each of the multiple different broker accounts, each of the multiple different broker accounts, trading, buying, selling, shorting, quantity, maximum quantity, month, day, year, trailing stop, or a combination thereof.

14) A system comprising:
a. one or more routing systems in communication with two or more broker accounts and real-time information regarding assets held within each of the two or more broker accounts;
b. a computer displaying one or more outputs from the one or more routing systems; and
c. one or more windows that display an aggregation of risk of all of the two or more broker accounts.

15) The system of claim 14, wherein the aggregation of risk is determined for each asset type in all of the two or more broker accounts, the aggregation of risk is displayed based upon user defined defaults or rules and the aggregation of risk dynamically changes as the real-time information changes, or both.

16) The system of claim 14, wherein the aggregation of risk is displayed in a first window for a total assets held within all of the two or more broker accounts, a second window displays the aggregation of risk for a first asset type, and a third window displays the aggregation of risk for a second asset type, and the one or more routing systems route assets based upon the aggregation of risk so that lower risk assets are routed before higher risk assets or vice versa.

17) A method comprising:
a. connecting one or more routing systems to multiple different broker accounts;
b. aggregating data from the multiple different broker accounts;
c. connecting the one or more routing systems to real-time information regarding assets held within each of the multiple different broker accounts;
d. calculating an aggregation of risk for all of the assets held within the multiple different broker account; and
e. outputting the aggregation of risk for all of the assets held within the multiple different broker accounts into the multi-broker system of claim 1 in a single output and displaying the aggregation of risk on a single display so that the aggregation of risk from all of the multiple broker accounts are visible simultaneously.

18) The method of claim 17, wherein the aggregation of risk is calculated for a total portfolio, each asset type, or both; the aggregation of risk is calculated for each asset within each of the multiple different broker accounts calculated for potential assets on a watch list; the aggregation of risk is varied based upon user defined defaults or rules; or both; and
wherein the aggregation of risk is calculated for the potential assets on the watch list including assets owned in all of the multiple different broker accounts so that the aggregation of risk including the potential assets is visible.

19) (canceled)

20) A method comprising:
a. connecting one or more routing systems to multiple different broker accounts;
b. aggregating data from the multiple different brokers;
c. outputting the aggregated data from the multiple different broker accounts into a single output in the multi-broker system of claim 1; and
d. inquiring whether an asset symbol is located within the aggregated data.

21) The method of claim 20, wherein if the inquiry states that the asset symbol is within the aggregated data then predetermined rules or defaults are maintained for the asset symbol; if the inquiry states that the asset symbol is new then the method requests predetermined rules or defaults to be established, and the predetermined rules or defaults are an asset type, order type, brokerage account, trading, buying, selling, shorting, quantity, maximum quantity, month, day, year, trailing stop, or a combination thereof; and
wherein the system requests an order, an order route is set for the asset symbol, the order is routed to a predetermined one of the multiple different broker accounts, or a combination thereof.

22) (canceled)
